(19) United States
(12) Patent Application Publication
(10) Pub. No.: US 2013/0172436 A1
(43) Pub. Date: Jul. 4, 2013

(54) POLYMERS CONTAINING HEAT LABILE COMPONENTS ADSORBED ON POLYMERIC CARRIERS AND METHODS FOR THEIR PREPARATION

(71) Applicants: Frank M. Fosco, JR., Plainfield, IL (US); Edward E. Sowers, Plainfield, IN (US)

(72) Inventors: Frank M. Fosco, JR., Plainfield, IL (US); Edward E. Sowers, Plainfield, IN (US)

(21) Appl. No.: 13/550,165

(22) Filed: Jul. 16, 2012

Related U.S. Application Data
(60) Provisional application No. 61/508,354, filed on Jul. 15, 2011.
(60) Provisional application No. 61/537,270, filed on Sep. 21, 2011.
(60) Provisional application No. 61/537,272, filed on Sep. 21, 2011.

(51) Int. Cl. C08K 5/544

(52) U.S. Cl. CPC C08K 5/544
USPC 521/145; 523/122; 521/146; 521/150; 521/142; 521/147; 521/154; 521/178; 521/182

(57) ABSTRACT

Compositions containing polymers and one or more heat labile and/or incompatible components adsorbed on carrier materials are provided. The heat labile components include materials that are inactivated, that volatilize, decompose, or undergo a chemical reaction or transformation at the polymer's processing temperatures (heat labile biocides). Incompatible components are materials that generally react or form gels or precipitates upon mixing. The carrier materials generally include inorganic or organic porous materials capable of remaining solid during processing temperatures. Methods for preparing the polymer compositions are provided.

### CROSS-REFERENCE TO RELATED APPLICATIONS

This application claims the benefit of U.S. Provisional Application No. 61/508,354, filed Jul. 15, 2011, U.S. Provisional Application No. 61/537,270, filed Sep. 21, 2011, and U.S. Provisional Application No. 61/537,272, filed Sep. 21, 2011, and incorporates all by reference herein, in their entirety.

### BACKGROUND

The present invention relates to a polymer composition including a heat labile component where the composition exhibits properties derived from the heat labile component after the composition has been processed at a temperature above the heat labile component's transformation temperature, The heat labile component's transformation temperature is a temperature at which the component is normally transformed by inactivation, volatilization, decomposition, chemical reaction, and combinations thereof. The compositions provided are prepared by a method which avoids transformation of the heat labile component when composition containing the component is processed at elevated temperatures above the component's transformation temperature.

The inclusion of a heat labile component such as, for example, a biocide into a polymer composition can offer important properties to the resulting polymer composition, provided transformation (decomposition) can be avoided. Such polymer/biocide compositions can be more resistant to biological degradation and provide surfaces that don't support the growth of a range of organisms and/or viruses and which can kill identified organisms (including bacteria, fungi, algae, viruses, and the like) which contact the surface. Such polymer/biocide compositions find particular uses in medical and related fields in which a need exists to create surfaces, equipment, and polymeric fabrics capable of: resisting the colonization of microorganisms, killing microorganisms upon contact, and/or providing a barrier to microorganisms. Unlike topical applications of biocides which typically provide a concentration gradient across the applied surface leading to resistant strains, a polymer having a uniform distribution of a biocide, provides a surface lacking such a concentration gradient and at proper levels minimizes the formation of resistant strains. In addition, the biocidal properties provided by the polymer/biocide composition are not dependent on whether a surface disinfectant was or was not applied according to established procedures. Further, the bulk of the polymer composition provides an ongoing reservoir of biocide for continued effect. The ability to provide and maintain such substantially sterile surfaces and minimize the formation of resistant strains of microorganisms is particularly important in today's hospital environment and in related fields.

Most polymers used to prepare surfaces associated with structures, articles, containers, devices, and fabrics (both woven and nonwoven) pass through a molten state at relatively high temperatures during processing. Depending on the polymer, such processing temperatures typically range from about 180° C. to about 550° C. For a heat labile component such as a biocide to be successfully incorporated into such a polymer composition utilizing these standard methods, it must typically have sufficient thermal stability to survive any necessary processing at the elevated temperatures. Currently only a limited number of inorganic biocides have been successfully incorporated to provide polymers that exhibit some level of biocidal activity utilizing common manufacturing practices. Decomposition while processing a melt phase of the polymer biocide has typically inactivated organic biocides included in the combination.

What is needed is a range of polymer/heat labile component compositions which can be engineered in a variety of forms utilizing substantially standard manufacturing techniques and which can include one or more heat labile components, such as for example, biocides selected to fulfill a specific need, without regard to whether or not the biocide is provided sufficient thermal stability to survive the necessary polymer processing. Further, methods are needed for producing such polymer/heat labile component compositions, wherein the heat labile component's necessary properties are maintained following one or several thermal processing steps. The current disclosure addresses these needs.

### SUMMARY

In its broadest form, the present disclosure provides for solid materials formed from a molten or liquid state and containing a heat labile component initially adsorbed in a carrier particle that alone and unassociated with the carrier particle would not be capable of surviving the conditions of the molten or liquid state. Although not required, the molten or liquid states typically occur at elevated temperatures. Failure of the component alone to survive can result from inactivation, decomposition, volatilization, chemical reaction and the like. In its broadest form, the present disclosure also provides a method for preparing the carrier loaded component and for incorporating the component/carrier combination into the molten material, mixing the combination, and solidifying the molten mixture to provide a substantially homogeneous solid containing the component, substantially unchanged. Polymers have proven particularly useful as solid materials capable of forming molten forms for this application.

A narrower perspective of the present disclosure provides for a polymer/biocide composition (a “biocidal polymer”) exhibiting antimicrobial properties wherein the composition was formed and/or processed at temperatures above the biocide's transformation or decomposition temperature, without substantial decomposition of the biocide. Further, methods are provided for preparing the polymer/biocide compositions.

In the discussions which follow, the focus will be on biocides as examples of heat labile components. However, it is understood that except for the nature of the properties exhibited, the concepts described for heat labile biocides relate to other heat labile components.

A first aspect of the present disclosure includes a composition comprising a polymer having a continuous solid phase and a heat labile component/carrier combination. The polymer has a melting temperature, the heat labile component has a transformation temperature, the polymer's melting temperature is greater than the heat labile component's transformation temperature, and the heat labile component/carrier combination is distributed throughout the polymer's continuous phase. One example includes a biocidal polymer comprising a homogeneous solid including a polymer having a melting temperature and a heat labile biocide adsorbed on a carrier and having a transformation or decomposition temperature where the polymers melting temperature is greater than the biocide's transformation or decomposition temperature. The carrier is typically a porous material which remains solid at the processing temperature upon which a sufficient amount of heat labile biocide can be adsorbed. In the polymer/biocide composition, the biocide is typically distributed throughout the polymer including its surface, but is not limited to placement on its surface.

Although some polymers can have melting temperatures as low as 100° C., preferred polymers typically have a melting temperature or a glass transition temperature (ranging from about 180° C. to about 550° C.) above which the polymer forms a viscous liquid to which a biocide/carrier combination can be added and mixed during processing. Such mixing provides for a generally uniform distribution of the various components within the mix and any subsequent article derived from the mix. Such polymers can include, but are not limited to organic polymers, inorganic polymers, copolymers including mixed organic/inorganic polymers, linear polymers, branched polymers, star polymers, and mixtures thereof. Depending on the biocide concentration, cooling and solidification of the resulting polymer/biocide composition can provide a product ranging from a concentrate (a “masterbatch”) for subsequent incorporation into additional polymer to a finished article. Such masterbatch materials can be based on a single polymer or on a polymer blend.

Suitable masterbatch combinations of a carrier/heat labile component and a second material can be a solid or a liquid. Such masterbatch combinations allow incorporation of the carrier/heat labile component into polymers during current manufacturing processes along with other solids, liquids, and/or combinations thereof. One such masterbatch embodiment involves a carrier/heat labile component incorporated into a polymer or polymer blend to provide a solid form, such as for example, a pellet or a powder form. Masterbatch materials can similarly involve a suspension or dispersion of the carrier/heat labile material in a liquid suitable for incorporation into a finished polymer material or article during manufacture. The liquid masterbatch formulation provides material handling advantages such as improved metering capabilities. Suitable liquid phase materials for the carrier dispersions or suspensions include, but are not limited to mineral oil, soybean oil, castor oil, linseed oil, alkyl phthalates, citric acid esters, and the like. Additional polymer additives can be included in the liquid masterbatch formulation such as colorants, plasticizers, UV stabilizers, and the like. As illustrated in the Examples, the carrier/heat labile component loading in such masterbatch materials is typically higher than intended in a finished product to account for dilution when combined with a bulk polymer.

Preferred biocides include, but are not limited to bacteriocides, fungicides, algicides, miticides, viruscides, insecticides, herbicides rodenticides, animal and insect repellants, and the like, which suffer some level of decomposition, inactivation, and/or volatilization at the temperatures required to incorporate the biocide into the polymer/biocide composition, and/or which offer some advantage to the resulting polymer/biocide combination. In other words, the heat labile biocide is inactivated, decomposes or vaporizes upon exposure to the elevated temperatures and/or processing conditions if not adsorbed on a carrier. For biocide mixtures, at least one of the biocide components is typically heat labile. One kind of suitable biocide includes biocides containing a quaternary amine group that accounts for some level of the compound's biocidal activity.

Suitable heat carriers are generally insoluble in the polymer's liquid phase, do not melt, or otherwise cease the function of a carrier during processing, and have a relatively high internal surface area. Carriers are porous and have an internal surface area to allow the adsorption of necessary levels of the biocide. The biocide can be adsorbed on the carrier by contacting the carrier with a liquid form of the biocide. If the biocide is a liquid at a temperature below its transition or decomposition temperature it can be used directly in its liquid form. If the biocide is a solid at the necessary processing temperatures, it can be dispersed or dissolved in a solvent, prior to adsorption onto the carrier. Any remaining solvent or dispersant can be removed or evaporated to provide a flowable carrier containing the biocide, for subsequent incorporation into a polymer. Solvents such as the lower boiling alcohols, for example, can be left on the carrier/biocide combination and volatilized upon contact with the molten polymer. For a carrier to be loaded with a dispersion of the biocide, the biocide's particle size should be smaller than the carrier's pores being entered. The term “transformation temperature” generally refers to a temperature at which a heat labile component is transformed by inactivation volatilization, decomposition, chemical reaction, and combinations thereof. The term “decomposition temperature” generally refers to the temperature at which a substance chemically decomposes to provide generally non-specific products.

A further aspect of the present disclosure involves a method for preparing the polymer/biocide composition described above. The method includes the steps of: providing a polymer and a heat labile component/carrier combination, subjecting the polymer to a processing temperature for a time sufficient to form a melt, distributing the heat labile component/carrier combination within the melt; and cooling the melt to form a continuous solid phase containing the heat labile component, with substantially no transformation of the heat labile component. The polymer has a melting temperature, the heat labile component has a transformation temperature, the processing temperature is ≧the polymer's melting temperature and the heat labile component's transformation temperature. No transformation of the heat labile component has taken place if the polymer/biocide composition is not discolored and the composition exhibits characteristics derived from the heat labile component.

A further variation of the method where the heat labile component is a biocide involves, (a) providing a mixture including a polymer or polymer phase and a heat labile component such as a biocide adsorbed on a carrier, wherein the polymer or polymer phase has a melting temperature, the biocide has a transformation or decomposition temperature; (b) subjecting the mixture to a processing temperature for a processing time sufficient to form a substantially homogeneous melt containing the polymer or polymer phase and the biocide adsorbed on the carrier; and (c) cooling the melt to solidify the polymer/biocide/carrier composition. Preferred carriers are porous and have a generally low thermal conductivity. The method can further include a step of processing prior or subsequent to the cooling process to cause the polymer to have a desired form. A desired form can include, but is not limited to pellets, granular particles, an extruded bar, sheet or film, a laminate, a powder, a machined form, a filament, a woven article, a container, and the like.

The time during which the polymer/biocide/carrier combination is subjected to a processing temperature should be sufficient to provide a generally uniform distribution of the biocide/carrier combination within the polymer melt; allow the resulting polymer/biocide/carrier combination to be conformed to and cooled in a desired form; but not so long that the biocide ultimately thermally decomposes. Preferred methods utilize a processing time of 30 minutes or less; more preferred methods utilize a processing time of 20 minutes or less, whereas the most preferred methods utilize a processing time of 15 minutes or less. Polymer/biocide combinations have been successfully prepared where the processing time ranged from as little as 1-2 minutes and as long as up to 30 minutes. Such processing times are applicable to the initial incorporation of the biocide/carrier combination into a polymer, whether a masterbatch or other desired form, and for any subsequent processing steps that require heating the polymer/biocide/carrier combination to temperatures at or above the biocide's decomposition temperature. Subjecting the polymer/biocide/carrier to extended periods of time above the biocide's decomposition temperature can ultimately result in biocide decomposition. How long the polymer/biocide/carrier combination can be maintained above the biocide's decomposition temperature depends primarily on the polymer selected, the carrier selected, the selected polymer's necessary processing temperature, and the biocide's rate of thermal decomposition or volatilization at the processing temperature of the selected polymer. Based on tests conducted thus far, additional cycles of heating and cooling can be carried out on the polymer/biocide combination for similar processing times without resulting loss of activity.

Finally, suitable heat labile components can include materials having a range of biological activities (controlling the growth of microorganisms, plants, and insects), volatiles, such as fragrances, repellants, pheromones, water and aqueous solutions, and materials which react or are inactivated by the exposure to elevated temperatures. In addition, other materials which are not heat labile will also likely benefit from the carrier technology provided. For example, the incorporation of materials such as plasticizers into carrier materials utilized in polymers may slow down the rate at which the plasticizer “blooms” to the plastic's surface, increasing its useful life. Additionally, mixtures of materials which are incompatible when mixed or otherwise combined can be loaded onto separate carriers and incorporated into a polymer to provide homogeneous compositions that could not otherwise be prepared. Incompatible components can include heat labile components and/or materials that would otherwise be stable at the processing temperatures.

A still further aspect of the current disclosure involves a composition that includes an encapsulated form of a heat labile component/carrier combination. Forms of the composition including higher levels of heat labile component/carrier combination are suitable for use as a masterbatch. Masterbatches can have a liquid or solid form suitable for incorporation into a polymer.

Additionally, the biocide or other heat labile component can be modified and/or extruded under conditions which result in it being concentrated closer to the extruded plastic's surface, thus further enhancing the extruded plastic's biocidal activity. In the discussions which follow, examples are provided in which a single heat labile component/carrier combination is utilized. It is understood that for some applications a single heat labile component/carrier may be utilized, for other applications, multiple heat labile components may be loaded onto a single carrier, and for still other applications, multiple heat labile component/carrier combinations can be utilized. Reference to a single combination is intended to also cover these additional combinations.

### DETAILED DESCRIPTION

For the purposes of promoting an understanding of what is claimed, references will now be made to the embodiments illustrated and specific language will be used to describe the same. It will nevertheless be understood that no limitation of scope of what is claimed is thereby intended, such alterations and further modifications and such further applications of the principles thereof as illustrated therein being contemplated as would normally occur to one skilled in the art to which the disclosure relates.

Broadly considered, the method disclosed herein, generally involves subjecting a heat labile component to a processing step carried out at processing temperatures above the component's transformation temperature, a temperature at which the component will become subject to inactivation volatilization, decomposition, a chemical reaction, or combinations thereof. Transformation of the heat labile component is avoided by first adsorbing the heat labile component onto a carrier prior to processing and by limiting the processing time. Suitable carriers are stable to the processing conditions and have the ability to load sufficient heat labile component, necessary for a particular application. The method generally provides for combinations including one or more heat labile components that could not otherwise be processed without decomposition and or which are incompatible with each other or other components. For example, some heat labile biocides are incompatible and can react, form a precipitate, a slime, and the like. For such incompatible biocides, a single heat labile biocide should be added to a single carrier. Other otherwise incompatible materials can more readily be handled and incorporated into the polymer by first being loaded into a carrier. Combinations of single biocide/carrier combinations can and have been combined in a masterbach material and extruded into polymer sheets without further evidence of incompatibility.

Heat labile components additionally involve materials that are volatile at a polymer's processing temperature and unless incorporated into a carrier. Incorporation of the volatile component into a carrier prior to incorporation into the polymer prevents substantial volatilization during processing. Volatile fragrances loaded into a carrier have been successfully incorporated into a range of polymers without decomposition or volatilization. The resulting polymer articles were capable of emitting the fragrance over a long period of time. Attempts to incorporate the fragrance into a polymer without being loaded into a carrier resulted in both volatilization and decomposition. Additionally, volatile materials such as animal and insect repellants can be successfully loaded into polymers without decomposition or volatilization to provide combinations capable of repelling animals and/or insects for long periods of time.

In the discussion which follows, specific compositions and methods will be described with regard to one or more heat labile components, such as biocides. It is understood that other heat labile materials discussed herein can be utilized similarly to provide a variety of solids from a molten phase which contain the other heat labile materials distributed throughout the solid.

A first aspect of the present disclosure involves a method for the incorporation of a heat labile component such as a biocide into a polymer phase at temperatures above the biocide's decomposition temperature without substantially decomposing the biocide or interfering with its properties. Prior to incorporation, the biocide is adsorbed onto a suitable carrier. Suitable carriers are porous materials capable of remaining solid at any necessary processing temperatures. Incorporation of the biocide/carrier combination into a polymer or other molten mass is carried out in a manner that minimizes the time the biocide/carrier combination is subjected to temperatures greater than the biocide's decomposition temperature. The processing temperature is typically determined by the properties of the polymer phase and the nature of the processing step. Once a processing temperature has been determined, combinations of polymer/carrier/biocide can be provided and maintained at that temperature for varying amounts of time to determine a maximum processing time.

Polymers:

Based on testing carried out at this time, polymers have had a glass transition temperature (or melting temperature) of at least 100° C. and more typically ranging from about 180° C. to about 550° C. At or above these temperatures the preferred polymers form a viscous liquid to which a biocide/carrier combination can be added and mixed during initial processing. Such polymers include, but are not limited to organic polymers, inorganic polymers, mixtures of organic and inorganic polymers, copolymers including mixed organic/inorganic polymers, linear polymers, branched polymers, star polymers, and mixtures thereof. A specific polymer or polymer combination is typically selected to provide the necessary physical properties for an application at an acceptable cost.

Polymers generally suitable for processing according to the current disclosure include, but are not limited to:

1. Polymers of monoolefins and diolefins, for example polypropylene, polyisobutylene, polybut-1-ene, poly-4-methylpent-1-ene, polyisoprene or polybutadiene, as well as polymers of cycloolefins, for instance of cyclopentene or norbornene, polyethylene (which optionally can be crosslinked), for example high density polyethylene (HDPE), low density polyethylene (LDPE), linear low density polyethylene (LLDPE), branched low density polyethylene (BLDPE) and medium density polyethylene (MDPE). Polyolefins, i.e. the polymers of monoolefins exemplified in the preceding paragraph, preferably polyethylene and polypropylene, can be prepared by different, and especially by the following, methods:
a) radical polymerization (normally under high pressure and at elevated temperature).
b) catalytic polymerization using a catalyst that normally contains one or more than one metal of groups IVb, Vb, VIb or VIII of the Periodic Table.
   These metals usually have one or more than one ligand, typically oxides, halides, alcoholates, esters, ethers, amines, alkyls, alkenyls and/or aryls that may be either p- or s-coordinated. These metal complexes may be in the free form or fixed on substrates, typically on activated magnesium chloride, titanium(III) chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or

ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EM), LLDPE/EVA, LLDPE/EM and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

5. Polystyrene, poly(p-methylstyrene), poly(α-methylstyrene).

6. Copolymers of styrene or α-methylstyrene with dienes or acrylic derivatives, for example styrene/butadiene, styrene/unsaturated ester, styrene/acrylonitrile, styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

7. Graft copolymers of styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, SAN, MBS, ASA or AES polymers.

8. Halogen-containing polymers such as polychloroprene, chlorinated rubbers, chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bis-glycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides and polybenzimidazoles.

18. Polyesters derived from dicarboxylic acids and diols and/or from hydroxycarboxylic acids or the corresponding lactones, for example polyethylene terephthalate, polytrimethylene terephthalate, polybutylene terephthalate, poly-1,4-dimethylolcyclohexane terephthalate and polyhydroxybenzoates, as well as block copolyether esters derived from hydroxyl-terminated polyethers; and also polyesters modified with polycarbonates or MBS. Polyesters and polyester copolymers as defined in U.S. Pat. No. 5,807,932 (column 2, line 53), incorporated herein by reference.

19. Polycarbonates and polyester carbonates.

20. Polysulfones, polyether sulfones and polyether ketones.

21. Crosslinked polymers derived from aldehydes on the one hand and phenols, ureas and melamines on the other hand, such as phenol/formaldehyde resins, urea/formaldehyde resins and melamine/formaldehyde resins.

22. Drying and non-drying alkyd resins.

23. Unsaturated polyester resins derived from copolyesters of saturated and unsaturated dicarboxylic acids with or without halogen-containing modifications thereof of low flammability.

24. Crosslinkable acrylic resins derived from substituted acrylates, for example epoxy acrylates, urethane acrylates or polyester acrylates.

25. Alkyd resins, polyester resins and acrylate resins crosslinked with melamine resins, urea resins, polyisocyanates or epoxy resins.

26. Epoxy resins derived from polyepoxides, for example from bis glycidyl ethers or from cycloaliphatic diepoxides.

27. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

28. Blends of the aforementioned polymers (polyblends), for example PP/EPDM, Polyamide/-EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO.

29. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

30. Aqueous emulsions of natural or synthetic rubber, e.g. natural latex or latices of carboxylated styrene/butadiene copolymers.

31. Polysiloxanes such as the soft, hydrophilic polysiloxanes described, for example, in U.S. Pat. No. 4,259,467; and the hard polyorganosiloxanes described, for example, in U.S. Pat. No. 4,355,147.

32. Polyketimines in combination with unsaturated acrylic polyacetoacetate resins or with unsaturated acrylic resins. The unsaturated acrylic resins include the urethane acrylates, polyether acrylates, vinyl or acryl copolymers with pendant unsaturated groups and the acrylated melamines. The polyketimines are prepared from polyamines and ketones in the presence of an acid catalyst.

33. Radiation curable compositions containing ethylenically unsaturated monomers or oligomers and a polyunsaturated aliphatic oligomer.

34. Epoxymelamine resins such as light-stable epoxy resins crosslinked by an epoxy functional coetherified high solids melamine resin such as LSE-4103 (Monsanto).

Resins that do not have a glass transition temperature because of cross-linking or for other reasons can be incorporated by mixing with another polymer having a glass transition temperature within a necessary temperature range.

The following polymers are particularly suitable for this application: polyvinylchloride, thermoplastic elastomers, polyurethanes, high density polyethylene, low density polyethylene, silicone polymers, fluorinated polyvinylchloride, polystyrene, styrene-acrylonitrile resin, polyethylene terephthalate, rayon, styrene ethylene butadiene styrene rubber, cellulose acetate butyrate, polyoxymethylene acetyl polymer, latex polymers, natural and synthetic rubbers, epoxide polymers (including powder coats), and polyamide6. Depending on the biocide concentration, cooling and solidification of the resulting polymer/biocide composition can provide a product ranging from a concentrate (a “masterbatch”) for subsequent incorporation into additional polymer or a finished article.

The carrier/biocide combination can also be incorporated into thermoset resins that reach elevated temperatures while curing. When the carrier/biocide combination is exposed to the curing temperatures, the biocide does not undergo transformation and imparts its biocidal properties to the cured thermoset resin. Examples of thermoset resins which can be loaded with the carrier;/biocide combination include, but are not limited to vinyl plastisol, polyesters, epoxy resin, polyurethanes, urea formaldehyde resins, vulcanized rubber, melamine, polyimide, and resins derived from various acrylated monomers & oligomers of epoxy, urethane, arylic, and the like commonly used to formulate UV curable systems.

The Biocides:

Biocides utilized according to the present disclosure are generally biocides which have reduced stability when exposed to required processing conditions at temperatures above their decomposition temperature. A majority are biocides which have limited heat stability that prevent their incorporation into polymers by standard methods.

Biocides generally suitable for processing according to the current disclosure include, but are not limited to: Acetylcarnitine, Acetylcholine, Aclidinium bromide, Acriflavinium chloride, Agelasine, Aliquat 336, Ambenonium chloride, Ambutonium bromide, Aminosteroid, Anilinium chloride, Atracurium besilate, Benzalkonium chloride, Benzethonium chloride, Benzilone, Benzododecinium bromide, Benzoxonium chloride, Benzyltrimethylammonium fluoride, Benzyltrimethylammonium hydroxide, Bephenium hydroxynaphthoate, Berberine, Betaine, Bethanechol, Bevonium, Bibenzonium bromide, Bretylium, Bretylium for the treatment of ventricular fibrillation, Burgess reagent, Butylscopolamine, Butyrylcholine, Candocuronium iodide, Carbachol, Carbethopendecinium bromide, Carnitine, Cefluprenam, Cetrimonium, Cetrimonium bromide, Cetrimonium chloride, Cetylpyridinium chloride, Chelerythrine, Chlorisondamine, Choline, Choline chloride, Cimetropium bromide, Cisatracurium besilate, Citicoline, Clidinium bromide, Clofilium, Cocamidopropyl betaine, Cocamidopropyl hydroxysultaine, Complanine, Cyanine, Decamethonium, 3-Dehydrocarnitine, Demecarium bromide, Denatonium, Dequalinium, Didecyldimethylammonium chloride, Dimethyldioctadecylammonium chloride, Dimethylphenylpiperazinium, Dimethyltubocurarinium chloride, DiOC6, Diphemanil metilsulfate, Diphthamide, Diquat, Distigmine, Domiphen bromide, Doxacurium chloride, Echothiophate, Edelfosine, Edrophonium, Emepronium bromide, Ethidium bromide, Euflavine, Fenpiverinium, Fentonium, Gallamine triethiodide, Gantacurium chloride, Glycine betaine aldehyde, Glycopyrrolate, Guar hydroxypropyltrimonium chloride, Hemicholinium-3, Hexafluoronium bromide, Hexamethonium, Hexocyclium, Homatropine, Hydroxyethylpromethazine, Ipratropium bromide, Isometamidium chloride, Isopropamide, Jatrorrhizine, Laudexium metilsulfate, Lucigenin, Mepenzolate, Methacholine, Methantheline, Methiodide, Methscopolamine, Methylatropine, Methylscopolamine, Metocurine, Miltefosine, MPP+, Muscarine, Neurine, Obidoxime, Otilonium bromide, Oxapium iodide, Oxyphenonium bromide, Palmatine, Pancuronium bromide, Pararosaniline, Pentamine, Penthienate, Pentolinium, Perifosine, Phellodendrine, Phosphocholine, Pinaverium, Pipecuronium bromide, Pipenzolate, Poldine, Polyquaternium, Pralidoxime, Prifinium bromide, Propantheline bromide, Prospidium chloride, Pyridostigmine, Pyrvinium, Quaternium-15, Quinapyramine, Rapacuronium, Rhodamine B, Rocuronium bromide, Safranin, Sanguinarine, Stearalkonium chloride, Succinylmonocholine, Suxamethonium chloride, Tetra-n-butylammonium bromide, Tetra-n-butylammonium fluoride, Tetrabutylammonium hydroxide, Tetrabutylammonium tribromide, Tetraethylammonium, Tetraethylammonium bromide, Tetramethylammonium chloride, Tetramethylammonium hydroxide, Tetramethylammonium pentafluoroxenate, Tetraoctylammonium bromide, Tetrapropylammonium perruthenate, Thiazinamium metilsulfate, Thioflavin, Thonzonium bromide, Tibezonium iodide, Tiemonium iodide, Timepidium bromide, Trazium, Tridihexethyl, Triethylcholine, Trigonelline, Trimethyl ammonium compounds, Trimethylglycine, Trolamine salicylate, Trospium chloride, Tubocurarine chloride, Vecuronium bromide.

Preferred heat labile biocides include, but are not limited to, quaternary amines and antibiotics. Some specific preferred heat labile biocides include, but are not limited to, N,N-didecyl-N-methyl-N-(3-trimethoxysilylpropyl)ammonium chloride, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, and N-didecyl-N-dimethyl-ammonium chloride.

Some specific antibiotics include, but are not limited to amoxicillin, campicillin, piperacillin, carbenicillin indanyl, methacillin cephalosporin cefaclor, streptomycin, tetracycline and the like. Preferred combinations of biocides generally include at least one heat labile biocide, which would not survive incorporation into a specific polymer unless adsorbed onto a carrier. Examples of preferred fungicides include iodopropynylbutylcarbamate; N-[(trichloromethyl)thio]phthalimide; and chlorothalonil. Examples of preferred bactericides include benzisothiazolinone and 5-chloro-2-methyl-4-isothiazolin-3-one. Other biocides which can be utilized according to this disclosure include, but are not limited to, bactericides, fungicides, algicides, miticides, viruscides, insecticides, acaricides, herbicides rodenticides, animal and insect repellants, and the like.

The Carriers:

Suitable carriers are typically porous materials capable of adsorbing the heat labile biocide, remaining in a solid form without decomposition during processing in a molten phase, and maintaining the biocide in the adsorbed state during processing. Carriers having a substantial porosity and a high surface area (mostly internal) are particularly preferred. A further useful property for a carrier is a relatively low thermal conductivity. Finally, for some applications, carriers which do not alter the color or appearance of the polymer are particularly preferred.

Carriers which have been utilized include, but are not limited to, inorganics such as platy minerals and polymers. Examples of inorganics include, but are not limited to fumed and other forms of silicon including precipitated silicon and vapor deposited silicon; clay; kaolin; perlite bentonite; talc; mica; calcium carbonate; titanium dioxide; zinc oxide; iron oxide; silicon dioxide; and the like. Mixtures of different carriers can also be utilized. Polymeric carriers should remain solid at elevated temperatures and be capable of loading sufficient quantities of biocide either into a pore system or through other means of incorporation. Suitable polymeric carriers include, but are not limited to, organic polymeric carriers such as cross-linked macroreticular and gel resins, and combinations thereof such as the so-called plum pudding polymers. The most preferred organic polymeric carriers include porous macroreticular resins, some of which can include other resins within the polymer's structure. Suitable resins for imbedding within a macroreticular resin include other macroreticular resins or gel resins. Additionally, other porous non-polymeric materials such as minerals can similarly be incorporated within the macroreticular resin.

Suitable organic polymeric carriers can include polymers lacking a functional group, such as a polystyrene resin, or carriers having a functional group such as a sulfonic acid included. Generally, any added functional group should not substantially reduce the organic polymeric carrier's thermal stability. A suitable organic polymeric carrier should be able to load a sufficient amount of biocide, and survive any processing conditions, and deliver an effective amount of the heat labile component such as a biocide upon incorporation into any subsequent system. Suitable organic polymeric carriers can be derived from a single monomer or a combination of monomers. Combinations of inorganic and organic carriers can be utilized.

General methods for preparing macroreticular and gel polymers are well known in the art utilizing a variety of monomers and monomer combinations. Suitable monomers for the preparation of organic polymeric carriers include, but are not limited to styrene, vinyl pyridines, ethylvinylbenzenes, vinyltoluenes, vinyl imidazoles, an ethylenically unsaturated monomers, such as, for example, acrylic ester monomers including methyl acrylate, ethyl acrylate, butyl acrylate, 2-ethylhexyl acrylate, decyl acrylate, methyl methacrylate, butyl methacrylate, lauryl(meth)acrylate, isobornyl(meth)acrylate, isodecyl(meth)acrylate, oleyl(meth)acrylate, palmityl(meth)acrylate, stearyl(meth)acrylate, hydroxyethyl (meth)acrylate, and hydroxypropyl (meth)acrylate; acrylamide or substituted acryl amides; styrene or substituted styrenes; butadiene; ethylene; vinyl acetate or other vinyl esters such as vinyl acetate, vinyl propionate, vinyl butyrate and vinyl laurate; vinyl ketones, including vinyl methyl ketone, vinyl ethyl ketone, vinyl isopropyl ketone, and methyl isopropenyl ketone; vinyl ethers, including vinyl methyl ether, vinyl ethyl ether, vinyl propyl ether, and vinyl isobutyl ether; vinyl monomers, such as, for example, vinyl chloride, vinylidene chloride, N-vinyl pyrrolidone; amino monomers, such as, for example, N,N′-dimethylamino(meth)acrylate; and acrylonitrile or methacrylonitrile; and the monomethacrylates of dialkylene glycols and polyalkylene glycols. Descriptions for making porous and macroreticular polymers can be found in U.S. Pat. No. 7,422,879 (Gebhard et al.) and U.S. Pat. No. 7,098,252 (Jiang et al.).

The organic polymeric carriers can contain other organic polymeric particles and/or other inorganic carrier particles, such as minerals typically characterized as platy materials. Minerals suitable for incorporation into a polymeric carrier include, but are not limited to fumed and other forms of silicon including precipitated silicon and vapor deposited silicon; clay; kaolin; perlite bentonite; talc; mica; calcium carbonate; titanium dioxide; zinc oxide; iron oxide; silicon dioxide; and the like. Mixtures of different carriers can also be utilized.

Selection of Components:

The choice of polymer(s) is generally made to provide an article having necessary and desired properties and a cost consistent with its use. The organic polymeric carriers are typically selected based on their porosity, surface area, and their ability to load sufficient biocide, and ultimate impact on the composition's properties. Porosity and surface area determine how much biocide can be loaded onto the organic polymeric carrier and generally reduces the amount of organic polymeric carrier required. The selection of biocide primarily depends on the use of the polymer/biocide combination. For example, the biocide loading can be tailored to target specific microorganisms or specific combinations of microorganisms, depending on the material's end use. Combinations of biocides can be utilized including both heat stabile and heat labile biocides in order to fulfill specific needs. In addition, combinations of biocides including bactericides, viruscides, fungicides, insecticides, herbicides, miticides, rodenticides, animal and insect repellants, and the like can be incorporated into a single polymer, depending on it end use. Additionally, incompatible materials, whether heat labile or not, can be loaded into separate carriers and incorporated into polymers.

The Process:

The carrier/biocide combination has been produced by contacting a carrier with a liquid form of the biocide (typically a solution or a suspension), allowing adsorption onto the organic polymeric carrier to occur and evaporating any solvent to provide the carrier/biocide combination in the form of a flow-able powder. Carrier loaded biocides containing as much as 60% biocides have been prepared. Multiple biocides can be loaded onto a single carrier, provided the multiple biocides are not incompatible. However, the utilization of a single biocide/single carrier combination avoids the issue of biocide incompatibility and offers advantages regarding flexibility with regard to the variety of available formulations.

The carrier/biocide combination has also been produced by encapsulating the carrier/biocide combination after and/or during the loading process. The encapsulation process can occur in parallel with separate carrier/biocide combinations that can then be combined and further encapsulated or the encapsulation process can be carried out sequentially. Parallel encapsulations have generally provided superior results when working with otherwise incompatible biocides. Generally the encapsulating agent is determined based on the carrier/biocide combination selected. For carriers involving SiO₂, TiO₂, and ZnO₂, N,N-Bis(3-aminopropyl)dodecylamine has been utilized as an encapsulating agent. The addition of Diisobutylphenoxyethoxyethyldimethylbenzyl ammonium chloride monohydrate and Iron Pure provides a biocidal effect and additionally assists in maintaining gasses and volatiles within the encapsulated carrier/biocide combination. The carrier/biocide combination can be constructed with a single encapsulation process, a double encapsulation process or can involve any number of encapsulations, depending on the desired properties and the number of components. Example 8 illustrates the encapsulation method described above.

To develop a method, a processing temperature is established for the polymer/carrier/biocide combination (or combination containing another heat labile component) and a maximum processing time at the processing temperature is established, before the processing is carried out. Processing equipment is selected to minimize melt time for the polymer/carrier/biocide combination. Conventional equipment for processing polymers can generally be used. Based on current work, single or twin thermal screws are effective for producing both masterbatch material and finished articles. Standard pellet extrusion has proven a useful method for producing masterbatch materials. Finished articles or intermediate forms of the polymer can be prepared by the following techniques: injection molding, roll molding, rotational molding, extrusion, casting, and the like. Organic polymeric carrier/biocide loading into the polymer melt can run at least as high as about 40 wt. % carrier/biocide. For masterbatch materials, the carrier/biocide concentration also typically runs as high as about 40 wt. %. Masterbatch materials are polymer/carrier/biocide combinations containing a high level of carrier/biocide for subsequent incorporation into a final polymer product through a subsequent processing step. Although masterbatch materials can take a variety of forms, they are typically provided in pellet form, and standard pellet extrusion has proven a useful method for producing masterbatch materials. As noted above, however, masterbach materials can also involve a liquid form including the carrier/heat labile component. For finished articles or intermediate forms, biocide levels in the range of about 0.25 wt. % to 10 wt. % have proven effective against microorganism's tested. However, even higher loadings are contemplated and will be effective.

Applications Utilizing Biocidal Polymers:

Applications involving the polymer/biocide combination taught herein include, but are not limited to a wide range of materials which can be used to form surfaces and equipment utilized in the medical and consumer fields including hospital, emergency treatment, first aid, and the like. Any product that is or could be prepared from a polymer melt or other fluid that otherwise requires processing at an elevated temperature and which would benefit from the ability to contain a heat labile component such as a biocide to limit the growth of microorganisms can be improved by utilizing the polymer/biocide combinations taught herein. Some specific examples of articles include, but are not limited to things we touch such as: counter tops, furniture components (e.g. a bed rail, a toilet seat, a shower stall, a sink, etc.), equipment (e.g. a bed pan, a door handle, shopping cart handles, a writing instrument, a computer keyboard, a telephone, toothbrush components, dental equipment, etc.), surgical equipment (e.g. clamps, surgeon's gloves, etc.), wound and hygiene products (e.g. bandages), and clothing (e.g. doctor's gown, patient's gown, nurses outer clothing, bedding, etc.). In addition, air filters constructed from porous forms of the polymer/biocide combination can minimize the microorganism content of the air circulating within a hospital, an office building, a hotel, a home, or other structure with central air handling equipment. Breathing masks and related portable air-filtering systems can similarly benefit from the use of filters constructed from the polymer/biocide combinations. In addition, filters suitable for handling other fluids such as liquids can similarly be passed through filters constructed from the polymer/biocide combination to cause reduction in the microorganism content of the fluid being treated. Finally, clothing constructed from fabrics prepared from the polymer/biocide combination can provide additional protection for individuals exposed to a range of biological hazards or weapons. Many of the articles above are also important components in schools, where colds, influenza, and the like typically spread quickly through surface contacts and air-born microorganisms. Polymers containing insecticides can be utilized to prepare articles such as siding, molding such as baseboards, carpeting, and the like to allow the killing of susceptible insects that contact the polymer/insecticide material. Fabrics including insecticides/miticides can be provided and incorporated into bedding supplies to control the reproduction and spread of organisms such as bed bugs and the like.

Finally, the present disclosure provides for polymeric materials utilizing the carrier technology which can contain components selected from the group consisting of bactericides, fungicides, insecticides, rodenticides, volatile fragrances (including animal and insect repellants), and the like. Such polymeric materials are particularly suitable for forming a variety of building materials, and for manufacturing garbage cans/bags and other equipment designed to handle garbage, food wastes, and the like. Articles manufactured from this polymeric material can mask odors, minimize bacterial and fungal growth, retard the proliferation of flies and other harmful insects, and prevent the proliferation of rodents. The incorporation of animal repellants in polymeric materials utilized for garbage handling equipment/articles handling food products can also keep pets and wild animals away. This is particularly desirable for garbage cans/bags awaiting pickup in unattended locations. Articles manufactured from polymeric materials containing combinations of these components can ultimately be recycled without leaching substantial amounts of biocides/pesticides into the environment.

### SPECIFIC EXAMPLES

### Example 1

### Preparation of Silica Loaded with N,N-Didecyl-N-Methyl-N-(3-trimethoxysilylpropyl)ammonium chloride

83 parts by weight of a methanolic solution containing 72% N,N-didecyl-N-methyl-N-(3-trimethoxysilylpropyl)ammonium chloride was combined with 40 parts by weight of fumed silica (SiO₂). The moist combination was mixed for about 5 minutes at ambient temperature in a high speed mixer at approximately 1200 rpm to provide a flowable powder. More dilute solutions of the biocide produces a wet paste, rather than a flowable powder. The resulting methanol wet carrier/quaternary salt can be incorporated into a polymer directly or dried before further use.

This method was used to prepare carrier/biocide combinations utilizing silica and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, and N-didecyl-N-dimethyl-ammonium chloride. Additionally, the method described above can also be utilized to prepare other carrier/biocide combinations utilizing the carriers including clay; kaolin; perlite bentonite; talc; mica; calcium carbonate; titanium dioxide; zinc oxide; and iron oxide.

Although multiple compatible biocides can be loaded into a single carrier, loading a single biocide into a single carrier is preferred when a combination of biocides utilized are incompatible. The single biocide/single carrier loading also allows greater flexibility in formulating a variety of biocide/polymer combinations. Multiple biocide/carrier combinations can be added to a single polymer at the masterbatch stage or when incorporated into a polymer product.

### Example 2

### Preparation of Polymer Loaded with N,N-didecyl-N-methyl-N-(3-trimethoxysilylpropyl)ammonium chloride

(a) Polymer selection and pretreatment: A commercial grade of the macroreticular crosslinked styrene/divinylbenzene resin, XAD™ 16, available from Rohm and Haas can be obtained, rinsed with water, dried, and ground to provide particles ranging from about 1 to about 100 nm. XAD is a common law trademark belonging to Rohm & Haas Company 100 Independence Mall West, Philadelphia, Pa. 19106-2399.

(b) Polymer Loading: 83 parts by weight of a methanolic solution containing 72% N,N-didecyl-N-methyl-N-(3-trimethoxysilylpropyl)ammonium chloride are combined with 25 parts by weight of the XAD™ 16 polymer pre-treated as described above. The moist combination is mixed for about 5 minutes at ambient temperature in a high speed mixer at approximately 1200 rpm to provide a flow able powder. More dilute solutions of the biocide produces a wet paste, rather than a flow able powder. The resulting methanol wet carrier/quaternary salt can be incorporated into a polymer directly or dried before further use.

This method can be used to prepare organic polymeric carrier/biocide combinations utilizing an organic polymeric carrier and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, and N-didecyl-N-dimethyl-ammonium chloride. Other suitable organic polymeric carriers can include resins, particularly macroreticular resins derived from styrene, acrylic acid, alkylacrylates, acrylamides, phenol/formaldehyde combinations, vinylpyridines, vinylimidazoles, combinations thereof, and the like. Gel and macroreticular resins can be unsubstituted or substituted. Polymers having lower levels of cross-linking will typically swell more during loading and are expected to provide greater carrier capacities than more heavily crosslinked resins. Preferred macroreticular resins have a surface area of at least about 50 m²/gm, more preferred resins have a surface area of at least about 200 m²/gm, and most preferred resins have a surface area of at least about 500 m²/gm. Commercially available macroreticular resins which can serve as carrier particles include, but are not limited to the resins, XAD™ 2, XAD™ 4, XAD™ 7, XAD™ 16, XAD™ 200, XAD™ 761, XAD™ 1180, and XAD™ 2010.

Although multiple compatible biocides can be loaded into a single carrier, loading a single biocide into a single carrier is preferred when a combination of biocides utilized are incompatible. The single biocide/single carrier loading also allows greater flexibility in formulating a variety of biocide/polymer combinations. Multiple biocide/carrier combinations can be added to a single polymer at the masterbatch stage or when incorporated into a polymer product.

### Example 3

### Preparation of Carrier/Polymer Masterbatch Pellets

A heated single thermal screw equipped with a port for addition of the carrier and a port for removal of methanol vapor was prepared for the thermal extrusion of polystyrene. Once molten polystyrene was moving through the extruder, the carrier/quat combination prepared above was added to the extruder at a rate to provide a polymer:carrier/biocide ratio of 60:40, by weight. Methanol and other volatiles were vented from the venting port. The extruder was operated to provide a polymer residence time within the extruder of about 1-2 minutes. The hot polymer was extruded into water to produce a pencil shaped extrusion product that was subsequently cut into pellets. The resulting wet pellets were separated from the water, dried, and sized for subsequent incorporation into polymer articles. Similar masterbatch pellets were prepared according to this procedure incorporating the carrier/biocide combinations including silica and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, or N-didecyl-N-dimethyl-ammonium chloride.

### Example 4

### Preparation of Organic Polymeric Carrier/Polymer Masterbatch Pellets

A heated single thermal screw equipped with a port for addition of the carrier and a port for removal of methanol vapor is prepared for the thermal extrusion of polystyrene. Once molten polystyrene is moving through the extruder, the carrier/quat combination prepared above is added to the extruder at a rate to provide a polymer:carrier/biocide ratio of about 60:40, by weight. Methanol and other volatiles are vented from the venting port. The extruder is operated to provide a polymer residence time within the extruder of about 1-2 minutes. The hot polymer is extruded into water to produce a pencil shaped extrusion product that is subsequently cut into pellets. The resulting wet pellets are separated from the water, dried, and sized for subsequent incorporation into polymer articles. Similar masterbatch pellets can be prepared according to this procedure incorporating the carrier/biocide combinations including a crosslinked macroreticular resin and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, or N-didecyl-N-dimethyl-ammonium chloride.

This procedure can also used to prepare similar masterbatch pellets utilizing polyvinylchloride, thermoplastic elastomers, polyurethanes, high density polyethylene, low density polyethylene, silicone polymers, fluorinated polyvinylchloride, styrene-acrylonitrile resin, polyethylene terephthalate, rayon, styrene ethylene butadiene styrene rubber, cellulose acetate butyrate, polyoxymethylene acetyl polymer, latex polymers, natural and synthetic rubbers, epoxide polymers (including powder coats), and polyamide6. Masterbatch pellets can similarly be made using a combination or blend of polymers.

For polymers that have high melt viscosities, a thermal screw extruder having good mixing is important in order to ensure the complete distribution of the carrier/biocide throughout the entire melt.

### Example 5

### Preparation of Articles from Masterbatch Pellets

A single screw heated extruder of the type described above for preparing the master batch material (prepared either in Example 1 or 2) is used to extrude a sheet form of the polymer. As in the method for preparing a master batch material, polystyrene is introduced into the extruder to provide a melt by the time material reached the addition port. The master batch material prepared above is added through the addition port to provide a ratio of biocide/polymer of about 0.25 wt. % to 10 wt. %. Residence time within the extruder is controlled between 1 and 2 minutes to provide polystyrene in a sheet form. Using the same equipment, and masterbatch pellets incorporating the other polymers listed or blends thereof, this procedure can be used to prepare sheet forms of polyvinylchloride, thermoplastic elastomers, polyurethanes, high density polyethylene, low density polyethylene, silicone polymers, fluorinated polyvinylchloride, styrene-acrylonitrile resin, polyethylene terephthalate, rayon, styrene ethylene butadiene styrene rubber, cellulose acetate butyrate, polyoxymethylene acetyl polymer, latex polymers, natural and synthetic rubbers, epoxide polymers (including powder coats), and polyamide6. All of the polymers are able to pass through the processing without color formation or other visible signs of biocide degradation. Depending on the polymer selected, residence times as long as 30 minutes can be utilized without decomposition of the biocide. Finally, the carrier/biocide combination formed in Example 1 can also be utilized directly with an appropriate dilution to prepare polymer loaded with biocide without utilizing the polymer masterbatch pellet material.

### Example 6

### Preparation of Polymer Loaded with an Antibiotic

About 80 parts of a methanolic suspension containing about 70% wt. % penicillin is combined with about 40 parts of the macroreticular polymer processed as described in Example 1 (a), above. The moist combination is mixed for about 5 minutes at ambient temperature in a high speed mixer at approximately 1200 rpm to provide a flow able powder. The resulting methanol wet carrier/antibiotic salt can be incorporated into a polymer directly or dried before further use.

This method can be used to prepare further carrier/antibiotic combinations utilizing silica and, amoxicillin, campicillin, piperacillin, carbenicillin indanyl, methacillin cephalosporin cefaclor, streptomycin, tetracycline and the like. Additionally, the method described above can also be utilized to prepare other carrier/biocide combinations involving other macroreticular resins derived monomers such as styrene, acrylic acid, alkylacrylates, acrylamides, phenol/formaldehyde combinations, vinylpyridines, vinylimidazoles, combinations thereof, and the like.

### Example 6

### The Incorporation of a Carrier/Antibiotic Combination into a Polymer Masterbatch and Polymer Article

The procedure described in Example 2 can be utilized to prepare antibiotic loaded polymer masterbatch pellets and the procedure described in Example 3 can be utilized to prepare antibiotic loaded polymer articles from the masterbatch pellets containing an antibiotic. Finally, the carrier/antibiotic combination can also be utilized directly with an appropriate dilution to prepare polymer loaded with antibiotic without utilizing the polymer masterbatch pellet material.

### Example 7

### Biological Tests

ASTM E 2180, the standard method for determining the activity of incorporated antimicrobial agents in polymers or hydrophobic material, is utilized to test untreated sheets of polypropylene and sheets of polypropylene containing 1% N,N-didecyl-N-methyl-N-(3-trimethoxysilylpropyl)ammonium chloride prepared according to the procedure described in Example 3 above. The samples are tested by pipetting a thin layer of inoculated agar slurry [Klebsiella Pneumoniae ATCC#4352, and Staphylococus aureus ATCC#6538] onto the untreated sheets and onto the treated sheets. Testing is carried out in triplicate. After 24 hours of contact at 35° C., surviving microorganisms are recovered into neutralizing broth. Serial dilutions are made, and bacterial colonies from each dilution series are counted and recorded. Percent reduction of bacteria from treated versus untreated samples are calculated.

The geometric mean of the number of organism recovered from the triplicate incubation period control and incubation period treated samples are calculated and the percent reduction was determined by the following formula:

$$\% reduction = \frac{a - b}{a} \times 100$$

where a=the antilog geometric mean of the number of organisms recovered from the incubation period control sample; and

b=the geometric mean of the number of organisms recovered from the incubation period treated samples.

Substantial reduction in the level of bacterial growth is obtained for regions in contact with the sheets containing the carrier/biocide combination.

The heat labile biocides described above can be similarly incorporated into the polymers described herein to provide polymer/biocide combinations which are capable of retarding the growth of microorganisms including, but not limited to E. coli, MRSA, Clostridium difficile, Aspergillus niger, and H1N1 Influenza A virus.

### Example 8

### Preparation of MACT™ 3.0, Biopolymer

### (a) Preparation of the Carrier Package:

250 grams of Si02, 200 grams, 200 grams of an solution of N Bis(3-aminopropyl) dodecylamine chloride (as a 60% N,N Bis(3-aminopropyl) dodecylamine chloride) and 40 grams of fumed silica (SiO₂) were combined and mixed in a high speed mixer (about 1200 rpm) for about 2 minutes at ambient temperature to provide a flowable powder. Sufficient amounts of additional dilute solutions of the N-Bis(3-aminopropyl)dodecylamine chloride were added to convert the flowable powder into a wet paste. The following components were added to the wet paste: 20 grams TiO2, 20 grams of Ion pure (silver iodide coated onto 5-10 micron glass beads), 30 grams of DIISOBULYLPHENOXYETHOXY ETHYL DIMETHYL BENZYL AMMONIUM CHLORIDE MONOHYDRATE, and 200 grams of aqueous N,N Bis(3-aminopropyl) dodecylamine chloride. The combination was compounded for about 2 minutes at ambient temperature at a low mix rate less than 1200 rpm to mix the moist paste and the resulting paste was compressed in a high speed shaker to remove any entrained air.

Additional components, 4.2 grams of N-ALKYL (C14-50%, C12-40%, C16-10%), 0.5 grams of SiO₂ and 0.5 grams of TiO₂ were incorporated into the thick paste as described above. Sufficient N,N-Bis(3-aminopropyl)dodecylamine chloride was added to maintain the material in the form of a thick paste that was thoroughly mixed. This process was repeated sequentially with the addition of biocides 3-29.

The following biocides were all included into the carrier package sequentially as described above:
(1) N,N-Bis(3-aminopropyl) dodecylamine chloride,
(2) N-ALKYL (C14-50%, C12-40%, C16-10%)
(3) DIMETHYL BENZYL AMMONIUM CHLORIDE,
(3) 1,3-BIS(HYDROXYMETHYL)-5,
(4) 5-DIMETHYLHYDANTOIN,1-(HYDROXYMETHYL)-5,5-DIMETHYLHYDANTOIN,
(6) 3-IODO-2-PROPYNYL BUTYL CARBAMATE,
(7) DIDECYL DIMETHYL AMMONIUM CHLORIDE,
(8) N-ALKYL (C14-50%, C12-40%, C16-10%) DIMETHYL BENZYL AMMONIUM CHLORIDE,
(9) 1,3-DI-(HYDROXYMETHYL)-5,5-DIMETHYLHYDANTOIN,
(10) 3-(HYDROXYMETHYL)-5,5-DIMETHYLHYDANTOIN, 5,5-DIMETHYLHYDANTOIN,
(11) 5-CHLORO-2-METHYL-4-ISOTHIAZOLIN-3-ONE,
(12) 2-METHYL-4-ISOTHIAZOLIN-3-ONE,
(13) N-ALKYL (C14-60%,C16.30%, C12-50%, C18-5%) DIMETHYL BENZYL AMMONIUM CHLORIDE,
(14) N-ALKYL (C12-50%, C14-30%, C16-17%, C18.3%) DIMETHYL BENZYL AMMONIUM CHLORIDE, DIOCTYL DIMETHYL AMMONIUM CHLORIDE, DIDECYL DIMETHYL AMMONIUM CHLORIDE,
(15) N,N-DIDECYL-N,N-DIMETHYLAMMONIUM CHLORIDE,
(16) ETHANE-1,2-DIOL, N,N BIS (3-AMINOPROPYL) DODECYLAMINE,
(17) DIMETHYL BENZYL AMMONIUM CHLORIDE,
(18) OCTYL DECYL DIMETHYL AMMONIUM CHLORIDE,
(19) DIOCTYL DIMETHYL AMMONIUM CHLORIDE,
(20) 1-BROMO-3-CHLORO-5,5-DIMETHYLHYDANTOIN,
(21) 3-BROMO-1-CHLORO-5,5-DIMETHYLHYDANTOIN,
(22) 1,3-DIBROMO-5,5-DIMETHYLHYDANTOIN,
(23) BORIC ACID
(24) N-TRICHLOROMETHYLTHIO-4-CYCLOHEXENE-1,2-DICARBOXIMIDE,
(25) N-(TRICHLOROMETHYLIO) PHTHAALIMIDE, CARBAMIC ACID
(26) BUTYL-,3-IODO-2-PROPYNYLESTER 55406-53-6,
(27) 3-IODO-2-PROPYNL BUTYL CARBAMATE,
(28) 3-IODO-2-PROPYNL BUTYL CARBAMATE,
(29) (TETRACHOROISOPHTHALONITRILE)

### Sample Preparation:

The general procedure described in Examples 3 and 4 was repeated to provide polypropylene samples plates for testing. A heated single thermal screw equipped with a port for addition of the carrier and an exhaust port for pressure relief was utilized. Once molten polypropylene was moving through the extruder, the carrier package prepared above was added to the extruder at a rate to provide a polymer/carrier package ratio of 60:40, by weight. The extruder was operated to provide a polymer residence time within the extruder of about 1-2 minutes. The molten polymer was extruded to produce solid in the form of plates for testing. Pencil shaped extrusion product was also produced by this method that was subsequently cooled and solidified in water and cut into pellets. The resulting wet pellets were separated from the water, dried, and sized for subsequent incorporation into polymer articles.

Testing of MACT™ 3.0, biopolymer:

The MACT™ 3.0, biopolymer was prepared according to the procedure described above and was evaluated according to the standard testing method (JIS Z 2801) developed for determining the ability of plastics and other antimicrobial surfaces to inhibit the growth of microorganisms or kill them, over a designated period of contact.

### An Overview of the JIS Z 2801 Test:

A test microorganism is prepared, typically by growth in a liquid culture medium. A suspension of test microorganism is standardized by dilution in a nutritive broth (affording microorganisms the potential to grow during the test). Both control and test surfaces are inoculated with microorganisms, typically in triplicate, and then the microbial inoculum is covered with a thin, sterile film or similar cover. By covering the inoculum it is spread, evaporation is prevented, and close contact with the antimicrobial surface is assured. Microbial concentrations are initially determined at “time zero” by elution followed by dilution and plating. Inoculated, covered control and antimicrobial test surfaces are allowed to incubate undisturbed in a humid environment for the test period, often 24 hours. Following incubation, microbial concentrations are determined. Calculations are carried out to determine the reduction of microorganisms relative to initial concentrations and the control surface.

### Surface Testing:

The JISZ 2801 Test Method was utilized to test plates of the polymer/carrier/biocides prepared in above and designated MACT™ 3.0. Tests conducted according to the JISZ 2801 method involved: Influenza A (H1N1) virus (ATCC VR-1469); Poliovirus type 1 (ATCC VR-1562); Vancomycin Resistant Enterococcus faecalis—VRE (ATCC 51575); Pseudomonas aeruginosa (ATCC 15442); Acinetobacter baumannii (ATCC 19606); Clostridium difficile-spore form (ATCC 43598); Methicillin Resistant Staphylococcus aureus-MRSA (ATCC 33592); and Aspergillus niger (ATCC 6275). The results are provided below:

### Antiviral Studies:

The following data analysis was utilized in evaluating the effectiveness of MACT™ 3.0, samples against viral strains.

### Calculation of Titers

Viral and cytotoxicity titers will be expressed as −log₁₀ of the 50 percent titration endpoint for infectivity (TCID₅₀) or cytotoxicity (TCD₅₀), respectively, as calculated by the method of Spearman Karber.

$$\text{-} Log of 1 st dilution inoculated - [ ( ( \frac{Sum of \% mortality at each dilution}{100} ) - 0.5 ) \times ( logarithm of dilution ) ]$$

$$Geometric Mean = Antilog of \text{:} \frac{{Log}_{10} {X}_{1} + {Log}_{10} {X}_{2} + {Log}_{10} {X}_{3}}{{3}^{*}}$$

(X equals TCID₅₀/0.1 mL of each test or control replicate)
*This value (or number of values for X) may be adjusted depending on the number of replicates requested.

### Calculation of Log Reduction

Zero Time Virus Control TCID₅₀−Test Substance TCID₅₀=Log Reduction and/or

Virus Control TCID₅₀−Test Substance TCID₅₀=Log Reduction

### Calculation of Percent Reduction

Calculation of Percent Reduction

$$\% Reduction = 1 - [ \frac{{TCID}_{50} test}{{TCID}_{50} zero time virus control} ] \times 100$$

$$and \text{/} or$$

$$\% Reduction = 1 - [ \frac{{TCID}_{50} test}{{TCID}_{50} virus control} ] \times 100$$

### Anti-Viral Test Results

A) Influenza A (H1N1) virus (ATCC VR-1469)

Under the conditions of this investigation and in the presence of a 1% fetal bovine serum organic soil load, MACT™ 3.0, (treated FDA grade plastic), demonstrated complete inactivation of Influenza A (H1N1) virus following a 2 hour exposure time at room temperature (20.0° C.) in a relative humidity of 50%.

The titer of the input virus control (starting titer of the virus) was 7.00 log₁₀. The virus recovered from the untreated FDA grade plastic following the 2 hour exposure time (2 hour virus control) was 7.00 log₁₀, indicating that virus was not lost during the 2 hour exposure time.

### Mean Reduction

MACT™ 3.0, demonstrated a ≧99.993% mean reduction in viral titer, as compared to the titer of the virus control held for the 2 hour exposure time.

The mean log reduction in viral titer was ≧4.17 log₁₀, as compared to the titer of the virus control held for the 2 hour exposure time.

### Individual Reduction

Replicate #1 and #3 demonstrated a ≧99.997% reduction in viral titer, as compared to the titer of the virus control held for the 2 hour exposure time.

The log reduction in viral titer was ≧4.50 log₁₀, as compared to the titer of the virus control held for the 2 hour exposure time.

Replicate #2 demonstrated a ≧99.97% reduction in viral titer, as compared to the titer of the virus control held for the 2 hour exposure time.

The log reduction in viral titer was ≧3.50 log₁₀, as compared to the titer of the virus control held for the 2 hour exposure time.

### B) Poliovirus Type 1 (ATCC VR-1562)

Results of tests with two samples of MACT™ 3.0, biopolymer, treated FDA grade plastic, exposed to Poliovirus type 1 in the presence of a 1% fetal bovine serum organic soil load at room temperature (20.0° C.) in a relative humidity of 50% for two and five minute exposure times. All cell controls were negative for test virus infectivity. The titer of the input virus control was 8.00 log₁₀. The titer of the zero time virus control (untreated FDA grade plastic) was 7.50 log₁₀. The titer of the virus controls (untreated FDA grade plastic) was 7.50 log₁₀ for the 2 minute exposure time and 8.25 log₁₀ for the 5 minute exposure time.

Following the 2 minute exposure time, test virus infectivity was detected at 6.50 log₁₀. Following the 5 minute exposure time, test virus infectivity was detected at 7.25 log₁₀. Test substance cytotoxicity was observed in the cytotoxicity control at 1.50 log₁₀. The neutralization control (non-virucidal level of the test substance) indicates that the test substance was neutralized at ≦1.50 log₁₀.

Under the conditions of this investigation and in the presence of a 1% fetal bovine serum organic soil load, MACT™ 3.0, biopolymer, treated FDA grade plastic, demonstrated a 90.0% reduction in viral titer following a 2 minute exposure time at room temperature (20.0° C.) in a relative humidity of 50% to Poliovirus type 1, as compared to the titer of the virus control held for the 2 minute exposure time. The log reduction in viral titer was 1.00 log₁₀, as compared to the titer of the virus control held for the 2 minute exposure time.

Under the conditions of this investigation and in the presence of a 1% fetal bovine serum organic soil load, MACT™ 3.0, biopolymer, treated FDA grade plastic, demonstrated a 90.0% reduction in viral titer following a 5 minute exposure time at room temperature (20.0° C.) in a relative humidity of 50% to Poliovirus type 1, as compared to the titer of the virus control held for the 5 minute exposure time. The log reduction in viral titer was 1.00 log₁₀, as compared to the titer of the virus control held for the 5 minute exposure time

### Antibacterial Studies:

The following general protocol for data analysis was utilized in evaluating the effectiveness of MACT™ 3.0, samples against bacterial strains.

### Number of Organisms Present on Carriers

$$CFU \text{/} carrier = \frac{\begin{matrix}( average CFU at a given dilution ) \times \\ ( dilution factor ) \times ( volume of neutralizer in mL )\end{matrix}}{( volume plated in mL )}$$

### Geometric Mean of Number of Organisms Surviving on the Test or Untreated Carriers

$$Geometric Mean = Antilog of \frac{{Log}_{10} {X}_{1} + {Log}_{10} {X}_{2} + … {Log}_{10} {X}_{N}}{N}$$

Where: X equals CFU/carrier
   N equals number of control carriers

### Percent Reduction Per Time Point Evaluated

% reduction=[(a−b)/a]×100
a=Geometric mean of the number of organisms surviving on the untreated carriers* at specified exposure time
b=Geometric mean of the number of organisms surviving on the test carriers at specified exposure time

### Log₁₀ Reduction Per Time Point Evaluated

Average Log₁₀ (CFU/untreated carrier*)−Average Log₁₀ (CFU/test carrier)

*Note: Test reductions were determined based on the side-by-side provided untreated control results. However, if the untreated material was not available or if the organism did not survive on the untreated carriers, the test percent and log reduction calculations may be calculated using:
the T₀ control results which offer a test reduction over time, not taking into consideration natural organism die-off.
the stainless steel control results which offer organism reductions in the test as compared to survival on a hard, non-porous surface.

### Log₁₀ Difference for the Neutralization Confirmation Control

Recovery Log Difference=(Log₁₀ NC Numbers Control)−(Log₁₀ NC Test Results)

### Anti-Bacterial Test Results

C) Vancomycin Resistant Enterococcus faecalis—VRE (ATCC 51575)

MACT™ 3.0, demonstrated a >99.99% (>4.42 Log₁₀) reduction of Vancomycin Resistant Enterococcus faecalis—VRE (ATCC 51575) following a 5 minute exposure time as compared to an untreated control material (FDA/Poly Pro) when tested in the presence of a 5% fetal bovine serum organic soil load at 35-37° C. with ≧90% relative humidity.

MACT™ 3.0, Platform, demonstrated a >99.99% (>4.58 Log₁₀) reduction of Vancomycin Resistant Enterococcus faecalis—VRE (ATCC 51575) following a 1 hour exposure time as compared to the untreated control material (FDA/Poly Pro) when tested in the presence of a 5% fetal bovine serum organic soil load at 35-37° C. with >90% relative humidity.

Under the conditions of this investigation, MACT™ 3.0, Platform, demonstrated a >99.99% (>4.42 Log₁₀) reduction of Vancomycin Resistant Enterococcus faecalis—VRE (ATCC 51575) following a 5 minute exposure time as compared to the untreated control material (FDA/Poly Pro) when tested in the presence of a 5% fetal bovine serum organic soil load at 35-37° C. with ≧90% relative humidity.

Under the conditions of this investigation, MACT™ 3.0, Platform, demonstrated a >99.99% (>4.58 Log₁₀) reduction of Vancomycin Resistant Enterococcus faecalis—VRE (ATCC 51575) following a 1 hour exposure time as compared to the untreated control material (FDA/Poly Pro) when tested in the presence of a 5% fetal bovine serum organic soil load at 35-37° C. with ≧90% relative humidity.

### D) Pseudomonas Aeruginosa (ATCC 15442)

MACT™ 3.0, biopolymer, demonstrated a >99.99% (>4.82 Log₁₀) reduction of Pseudomonas aeruginosa (ATCC 15442) following a 5 minute exposure time as compared to the untreated control material (FDA/Poly Pro) when tested in the presence of a 5% fetal bovine serum organic soil load at 35-37° C. with ≧90% relative humidity.

MACT™ 3.0, biopolymer, demonstrated a >99.99% (>4.63 Log₁₀) reduction of Pseudomonas aeruginosa (ATCC 15442) following a 1 hour exposure time as compared to the untreated control material (FDA/Poly Pro) when tested in the presence of a 5% fetal bovine serum organic soil load at 35-37° C. with ≧90% relative humidity.

Under the conditions of this investigation, MACT™ 3.0, biopolymer, demonstrated a >99.99% (>4.82 Log₁₀) reduction of Pseudomonas aeruginosa (ATCC 15442) following a 5 minute exposure time as compared to the untreated control material (FDA/Poly Pro) when tested in the presence of a 5% fetal bovine serum organic soil load at 35-37° C. with ≧90% relative humidity.

Under the conditions of this investigation, MACT™ 3.0, biopolymer demonstrated a >99.99% (>4.63 Log₁₀) reduction of Pseudomonas aeruginosa (ATCC 15442) following a 1 hour exposure time as compared to the untreated control material (FDA/Poly Pro) when tested in the presence of a 5% fetal bovine serum organic soil load at 35-37° C. with ≧90% relative humidity.

### E) Acinetobacter Baumannii (ATCC 19606)

MACT™ 3.0, biopolymer, demonstrated a >99.99% (>4.34 Log₁₀) reduction of Acinetobacter baumannii (ATCC 19606) following a 5 minute exposure time as compared to the untreated control material (FDA/Poly Pro) when tested in the presence of a 5% fetal bovine serum organic soil load at 35-37° C. with ≧90% relative humidity.

MACT™ 3.0, biopolymer, demonstrated a >99.99% (>4.60 Log₁₀) reduction of Acinetobacter baumannii (ATCC 19606) following a 1 hour exposure time as compared to the untreated control material (FDA/Poly Pro) when tested in the presence of a 5% fetal bovine serum organic soil load at 35-37° C. with ≧90% relative humidity.

Under the conditions of this investigation, MACT™ 3.0, biopolymer demonstrated a >99.99% (>4.34 Log₁₀) reduction of Acinetobacter baumannii following a 5 minute exposure time as compared to the untreated control material (FDA/Poly Pro) when tested in the presence of a 5% fetal bovine serum organic soil load at 35-37° C. with ≧90% relative humidity.

Under the conditions of this investigation, MACT™ 3.0, biopolymer demonstrated a >99.99% (>4.60 Log₁₀) reduction of Acinetobacter baumannii following a 1 hour exposure time as compared to the untreated control material (FDA/Poly Pro) when tested in the presence of a 5% fetal bovine serum organic soil load at 35-37° C. with ≧90% relative humidity.

F) Clostridium difficile—Spore Form (ATCC 43598)

MACT™ 3.0, biopolymer, demonstrated a <79.7% (<0.69 Log₁₀) reduction of Clostridium difficile—spore form (ATCC 43598) following a 2 hour exposure time as compared to the untreated control material (FDA/Poly Pro) when tested in the presence of a 5% fetal bovine serum organic soil load at 35-37° C. with ≧90% relative humidity.

Under the conditions of this investigation, MACT™ 3.0, biopolymer demonstrated a <79.7% (<0.69 Log₁₀) reduction of Clostridium difficile-spore form following a 2 hour exposure time as compared to the untreated control material (FDA/Poly Pro) when tested in the presence of a 5% fetal bovine serum organic soil load at 35-37° C. with ≧90% relative humidity.

G) Methicillin Resistant Staphylococcus aureus-MRSA (ATCC 33592)

MACT™ 3.0, demonstrated a >99.99% (>4.44 Log₁₀) reduction of Methicillin Resistant Staphylococcus aureus-MRSA (ATCC 33592) following a 55 second exposure time as compared to the untreated control material (FDA/Poly Pro) when tested in the presence of a 5% fetal bovine serum organic soil load at 35-37° C. with ≧85% relative humidity.

MACT™ 3.0, demonstrated a >99.99% (>4.57 Log₁₀) reduction of Methicillin Resistant Staphylococcus aureus—MRSA (ATCC 33592) following a 2 minute exposure time as compared to the untreated control material (FDA/Poly Pro) when tested in the presence of a 5% fetal bovine serum organic soil load at 35-37° C. with ≧88% relative humidity.

MACT™ 3.0, demonstrated a >99.99% (>4.54 Log₁₀) reduction of Methicillin Resistant Staphylococcus aureus—MRSA (ATCC 33592) following a 1 hour exposure time as compared to the untreated control material (FDA/Poly Pro) when tested in the presence of a 5% fetal bovine serum organic soil load at 35-37° C. with ≧90% relative humidity.

### Anti-Fungal Test Results

H) Aspergillus niger (ATCC 6275)

The following protocol for data analysis described above for the bacterial studies was utilized in evaluating the effectiveness of MACT™ 3.0, samples against this fungal strain.

MACT™ 3.0, demonstrated no reduction of Aspergillus niger (ATCC 6275) following a 5 minute exposure time as compared to the untreated control material (FDA/Poly Pro) when tested in the presence of a 5% fetal bovine serum organic soil load at 35-37° C. with ≧90% relative humidity.

MACT™ 3.0, demonstrated a 64.5% (0.45 Log₁₀) reduction of Aspergillus niger (ATCC 6275) following a 1 hour exposure time as compared to the untreated control material (FDA/Poly Pro) when tested in the presence of a 5% fetal bovine serum organic soil load at 35-37° C. with ≧90% relative humidity.

The present invention contemplates modifications as would occur to those skilled in the art. It is also contemplated that a variety of materials incapable of surviving intimate contact with a molten phase at elevated temperatures can survive such processing by first being incorporated into an appropriate carrier material as disclosed herein, and that such variation of the present disclosure might occur to those skilled in the art without departing from the spirit of the present invention. All publications cited in this specification are herein incorporated by reference as if each individual publication was specifically and individually indicated to be incorporated by reference and set forth in its entirety herein.

While the disclosure has been illustrated and described in detail in the figures and foregoing description, the same is to be considered as illustrative and not restrictive in character, it being understood that only selected embodiments have been shown and described and that all changes, modifications and equivalents that come within the spirit of the disclosures described heretofore and/or defined by the following claims are desired to be protected. In addition, all publications cited herein are indicative of the level of skill in the art and are hereby incorporated by reference in their entirety as if each had been individually incorporated by reference and fully set forth.

1. A composition comprising a polymer having a continuous solid phase, and a heat labile component/carrier combination, wherein:
(a) the polymer has a melting temperature;
(b) the heat labile component has a transformation temperature;
(c) the polymer's melting temperature is greater than the heat labile component's transformation temperature;
(d) the heat labile component/carrier combination is distributed throughout the polymer's continuous solid phase; and
(e) the continuous solid phase exhibits at least one property derived from the heat labile component.

2. The composition of claim 1, wherein the heat labile component/carrier combination involves a carrier loaded with a heat labile component and the combination is encapsulated within the polymer's continuous phase.

3. The composition of claim 1, wherein the heat labile component/carrier combination is encapsulated with an encapsulating agent and the encapsulated heat labile component/carrier combination is distributed within the polymer's continuous phase.

4. The composition of claim 3, wherein the heat labile component is a biocide.

5. The composition of claim 4, wherein the biocide is selected from the group consisting of bacteriocides, fungicides, algicides, miticides, viruscides, insecticides, herbicides rodenticides, pheromones, animal repellants and insect repellants.

6. The composition of claim 1, wherein the transformation temperature is a temperature at which the heat labile component is transformed by a process selected from the group consisting of inactivation, volatilization, decomposition, and chemical reaction.

7. The composition of claim 1, wherein the polymer is selected from the group consisting of a polyvinylchloride, a thermoplastic elastomer, a polyurethane, a high density polyethylene, a low density polyethylene, a silicone polymer, a fluorinated polyvinylchloride, a polystyrene, a styrene-acrylonitrile resin, a polyethylene terephthalate, a rayon, a styrene ethylene butadiene styrene rubber, a cellulose acetate butyrate, a polyoxymethylene acetyl polymer, a latex polymer, a natural rubber, a synthetic rubber, an epoxide polymer (including powder coats), and a polyamide6.

8. The composition of claim 1, wherein the polymer is a thermoset resin selected from the group consisting of vinyl plastisol, polyesters, epoxy resin, polyurethanes, urea formaldehyde resins, vulcanized rubber, melamine, polyimide, and resins derived from various acrylated monomers & oligomers of epoxy, urethane, arylic.

9. The composition of claim 1, wherein the carrier is a porous inorganic material.

10. The composition of claim 1, wherein the carrier is a porous organic material.

11. The composition of claim 1, wherein the heat labile component is a volatile component and the transformation temperature is the component's volatilization temperature.

12. The composition of claim 11, wherein the volatile component is selected from the group consisting of fragrances, repellants, pheromones, water and aqueous solutions.

13. A method for preparing a composition comprising:
(a) providing a polymer and a heat labile component/carrier combination, wherein the polymer has a melting temperature and the heat labile component has a transformation temperature;
(b) subjecting the polymer to a processing temperature for a time sufficient to form a melt;
(c) distributing the heat labile component/carrier combination within the melt; and
(d) cooling the melt to form a continuous solid phase containing the heat labile component, with substantially no transformation of the heat labile component;
wherein the processing temperature is ≧the polymer's melting temperature and the heat labile component's transformation temperature.

14. The method of claim 13, wherein providing a polymer and a heat labile component/carrier combination involves providing an encapsulated heat labile component/carrier combination.

15. The method of claim 14, wherein providing a heat labile component/carrier combination involves providing a biocide/carrier combination and the biocide's transformation temperature is its decomposition temperature.

16. The method of claim 15, wherein providing a biocide/carrier combination includes a biocide selected from the group consisting of bacteriocides, fungicides, algicides, miticides, viruscides, insecticides, herbicides rodenticides, pheromones, animal repellants and insect repellants.

17. The method of claim 14, wherein, providing a heat labile component/carrier combination involves providing a volatile component/carrier combination and the volatile component's transformation temperature is its volatilization temperature.

18. The method of claim 17, wherein providing a volatile component/carrier combination involves a volatile component selected from the group consisting of fragrances, repellants, pheromones, water and aqueous solutions.

19. The method of claim 14, wherein the polymer provided is selected from the group consisting of a polyvinylchloride, a thermoplastic elastomer, a polyurethane, a high density polyethylene, a low density polyethylene, a silicone polymer, a fluorinated polyvinylchloride, a polystyrene, a styrene-acrylonitrile resin, a polyethylene terephthalate, a rayon, a styrene ethylene butadiene styrene rubber, a cellulose acetate butyrate, a polyoxymethylene acetyl polymer, a latex polymer, a natural rubber, a synthetic rubber, an epoxide polymer (including powder coats), and a polyamide6.

20. The method of claim 14, wherein providing a polymer and a heat labile component/carrier combination involves providing a porous organic carrier.

21. The method of claim 20, wherein providing a polymer and a heat labile component/porous organic carrier combination involves providing a porous organic carrier prepared from a monomer selected from the group consisting of styrene; vinyl pyridines; ethylvinylbenzenes; vinyltoluenes; vinyl imidazoles; methyl acrylate; ethyl acrylate; butyl acrylate; 2-ethylhexyl acrylate; decyl acrylate; methyl methacrylate; butyl methacrylate; lauryl(meth)acrylate; isobornyl(meth)acrylate; isodecyl(meth)acrylate; oleyl(meth)acrylate; palmityl(meth)acrylate; stearyl(meth)acrylate; hydroxyethyl (meth)acrylate; and hydroxypropyl (meth)acrylate; acrylamide; a substituted acryl amide; a substituted styrene; butadiene; ethylene; vinyl acetate; vinyl acetate; vinyl propionate; vinyl butyrate; vinyl laurate; vinyl methyl ketone; vinyl ethyl ketone; vinyl isopropyl ketone; methyl isopropenyl ketone; vinyl methyl ether; vinyl ethyl ether; vinyl propyl ether; vinyl isobutyl ether; vinyl chloride; vinylidene chloride; N-vinyl pyrrolidone; N,N′-dimethylamino(meth)acrylate; acrylonitrile; methacrylonitrile; a monomethacrylates of dialkylene glycol; a monomethacrylates of polyalkylene glycol and combinations thereof.

22. The method of claim 14, wherein providing a polymer and a heat labile component/carrier combination involves providing a porous inorganic carrier.

23. The method of claim 22, wherein providing a polymer and a heat labile component/porous inorganic carrier combination involves providing a porous inorganic carrier selected from the group consisting of fumed silicon; precipitated silicon; vapor deposited silicon; clay; kaolin; perlite; bentonite; talc; mica; calcium carbonate; titanium dioxide; zinc oxide; iron oxide; silicon dioxide; and combinations thereof.

24. The method of claim 14, wherein subjecting the polymer to a processing temperature involves subjecting the polymer to a temperature ≧100° C.

25. The method of claim 24, wherein subjecting the polymer to a processing temperature involves subjecting the polymer to a temperature ≧180° C.

26. A composition comprising at least one encapsulated form of a heat labile component/carrier combination suitable for inclusion into a molten polymer without transformation of the at least one heat labile component.

27. The composition of claim 26, wherein the at least one heat labile component/carrier combination is encapsulated within a solid to form a masterbatch material.

28. The composition of claim 27, wherein the solid is a polymer.

29. The composition of claim 26, wherein the at least one heat labile component/carrier combination is encapsulated within a liquid formulation to form a masterbatch material.
